(19) United States
(12) Patent Application Publication
(10) Pub. No.: US 2019/0259508 A1
(43) Pub. Date: Aug. 22, 2019

(54) CONNECTOR TERMINAL WIRE

(71) Applicants: SUMITOMO ELECTRIC INDUSTRIES, LTD., Osaka-shi, Oasaka (JP); SUMITOMO ELECTRIC TOYAMA CO., LTD., Imizu-shi, Toyama (JP)

(72) Inventors: Akiko Inoue, Osaka-shi, Osaka (JP); Kei Sakamoto, Osaka-shi, Osaka (JP); Tetsuya Kuwabara, Osaka-shi, Osaka (JP); Taichiro Nishikawa, Osaka-shi, Osaka (JP); Kiyotaka Utsunomiya, Osaka-shi, Osaka (JP); Minoru Nakamoto, Osaka-shi, Osaka (JP); Yusuke Oshima, Osaka-shi, Osaka (JP); Yoshihiro Nakai, Osaka-shi, Osaka (JP); Kazuhiro Nanjo, Osaka-shi, Osaka (US); Hitoshi Tsuchida, Imizu-shi, Toyama (JP); Dai Kamogawa, Imizu-shi, Toyama (JP)

(73) Assignees: SUMITOMO ELECTRIC INDUSTRIES, LTD., Osaka-shi, Osaka (JP); SUMITOMO ELECTRIC TOYAMA CO., LTD., Imizu-shi, Toyama (JP)

(21) Appl. No.: 16/348,112

(22) PCT Filed: Sep. 12, 2017
(86) PCT No.: PCT/JP2017/032940

§ 371 Date: May 7, 2019

(30) Foreign Application Priority Data
Nov. 7, 2016 (JP) 2016-217048
Apr. 25, 2017 (JP) 2017-086602

(51) Int. Cl. H01B 1/02; H01R 4/58; C22C 9/02; C22F 1/08

(52) U.S. Cl. CPC H01B 1/026; H01R 4/58; H01R 12/58; C22F 1/08; C22C 9/02

(57) ABSTRACT

A connector terminal wire contains 0.1% by mass or more and 1.5% by mass or less of Fe, 0.02% by mass or more and 0.7% by mass or less of P, and 0% by mass or more and 0.7% by mass or less, in total, of at least one of Sn and Mg, with the balance being Cu and impurities.

### TECHNICAL FIELD

The present invention relates to a connector terminal wire.

The present application is based upon and claims the benefit of priority from Japanese Patent Application No. 2016-217048, filed Nov. 7, 2016, and Japanese Patent Application No. 2017-086602, filed Apr. 25, 2017, the entire contents of which are incorporated herein by reference.

### BACKGROUND ART

A press-fit terminal is one example of a connector terminal (for example, refer to Patent Literature 1). The press-fit terminal is a rod-shaped material that can be connected to a printed board in a solderless manner. By connecting one end of a press-fit terminal to a counter member and press-fitting the other end thereof in a printed board, the counter member and the printed board are electrically and mechanically connected to each other. The constituent material for the connector terminal may be pure copper, such as tough pitch copper; a copper alloy, such as brass; or iron ([0026] of Patent Literature 1, etc). In addition, as a material having an excellent spring property, phosphor bronze or the like may be used.

### CITATION LIST

### Patent Literature

PTL 1: Japanese Unexamined Patent Application Publication No. 2014-149956

### SUMMARY OF INVENTION

A connector terminal wire according to the present disclosure contains 0.1% by mass or more and 1.5% by mass or less of Fe, 0.02% by mass or more and 0.7% by mass or less of P, and 0% by mass or more and 0.7% by mass or less, in total, of at least one of Sn and Mg, with the balance being Cu and impurities.

### DESCRIPTION OF EMBODIMENTS

### Problems to be Solved by the Present Disclosure

A connector terminal, such as a press-fit terminal, is required to have excellent conductivity, high rigidity, and a high spring property. Accordingly, the materials for such a connector terminal are required to have excellent conductivity and high strength.

The above-described tough pitch copper and brass have excellent conductivity but low strength and a poor spring property. The above-described iron and phosphor bronze have high strength and an excellent spring property but a low conductivity. Such materials cannot sufficiently meet the requirement for excellence in both conductivity and strength.

Recently, along with reduction in size and thickness of electrical/electronic devices, reduction in size of components has been required. In order to form a smaller connector terminal, even in the case where the cross-sectional area of a wire is decreased or a wire is thinned, a wire having excellent conductivity and higher strength is required so that a connector terminal having excellent conductivity and high strength can be formed.

Accordingly, one object is to provide a connector terminal wire that can form a connector terminal having excellent conductivity and high strength.

### Advantageous Effects of the Present Disclosure

The connector terminal wire according to the present disclosure can form a connector terminal having excellent conductivity and high strength.

### DESCRIPTION OF EMBODIMENTS OF THE PRESENT INVENTION

First, the contents of embodiments of the present invention will be enumerated and described.

(1) A connector terminal wire according to an embodiment of the present invention contains 0.1% by mass or more and 1.5% by mass or less of Fe, 0.02% by mass or more and 0.7% by mass or less of P, and 0% by mass or more and 0.7% by mass or less, in total, of at least one of Sn and Mg, with the balance being Cu and impurities.

The connector terminal wire is composed of a copper alloy having a specific composition and, therefore, has excellent conductivity, high strength, excellent rigidity, and an excellent spring property. The reason for this is that, in the copper alloy, Fe and P exist as precipitates or crystallized products containing Fe and P, typically, as compounds, such as Fe₂P, in the matrix phase (Cu), and exhibit a strength-improving effect due to precipitation strengthening and an effect of maintaining a high conductivity due to reduced solid solution in Cu. In the case where the connector terminal wire contains at least one of Sn and Mg, a further improvement in strength due to solid-solution strengthening of these elements can be expected. Such a connector terminal wire can be suitably used as a material for a connector terminal, such as a press-fit terminal, which is required to have excellent conductivity, high rigidity, and a high spring property.

(2) According to an exemplary embodiment of the connector terminal wire, the connector terminal wire contains 0.01% by mass or more and 0.7% by mass or less, in total, of at least one of Sn and Mg.

Since the above-described embodiment contains at least one of Sn and Mg in a specific range, higher strength can be achieved by solid-solution strengthening. Therefore, according to the above-described embodiment, it is possible to form a connector terminal having excellent conductivity and higher strength.

(3) According to an exemplary embodiment of the connector terminal wire, the ratio Fe/P, by mass, is 1.0 or more and 10 or less.

In the embodiment described above, an excess or deficient amount of Fe relative to P is small, and Fe is incorporated properly relative to P. Thus, Fe and P exist in the form of the precipitates or the like, precipitation strengthening and, in particular, reduced solid solution of P in Cu can be properly achieved, and excellent conductivity and high strength can be obtained. Therefore, according to the above-described embodiment, it is possible to form a connector terminal having excellent conductivity and high strength.

(4) According to an exemplary embodiment of the connector terminal wire, the connector terminal wire contains, in mass ratio, 10 ppm or more and 500 ppm or less, in total, of one or more elements selected from the group consisting of C, Si, and Mn.

When the connector terminal wire contains C, Si, and Mn in a specific range, C, Si, and Mn each function as a deoxidizing agent for Fe, P, Sn, and the like, and by reducing and preventing oxidation of these elements, the effect of achieving high conductivity and high strength due to incorporation of these elements can be appropriately obtained. Furthermore, in the above-described embodiment, from the standpoint of being able to suppress a decrease in conductivity due to excessive contents of C, Si, and Mn, excellent conductivity is obtained. Therefore, according to the above-described embodiment, it is possible to form a connector terminal having excellent conductivity and high strength.

(5) According to an exemplary embodiment of the connector terminal wire, the connector terminal wire has a conductivity of 40% IACS or more and a tensile strength of 600 MPa or more.

The above-described embodiment has a high conductivity and a high tensile strength, and it is possible to form a connector terminal having excellent conductivity and high strength.

(6) According to an exemplary embodiment of the connector terminal wire, the connector terminal wire has a stress relaxation rate of 30% or less after it has been held at 150° C. for a predetermined time selected from a range of 200 hours or more and 1,000 hours or less.

The above-described embodiment has excellent conductivity and high strength, and even in the case where the connector terminal wire is held at a high temperature, such as 150° C., for a long period of time, stress relaxation is unlikely to occur. Thus, it is possible to form a connector terminal having an excellent stress relaxation property.

(7) According to an exemplary embodiment of the connector terminal wire, the connector terminal wire has a cross-sectional area of 0.1 mm² or more and 2.0 mm² or less.

The above-described embodiment is of a size that is easily used for a material for a connector terminal, such as a press-fit terminal, and can be suitably used as a material for the connector terminal.

(8) According to an exemplary embodiment of the connector terminal wire, the connector terminal wire is a rectangular wire whose cross-sectional shape is quadrilateral.

The above-described embodiment is of a shape that is easily used for a material for a connector terminal, such as a press-fit terminal, and can be suitably used as a material for the connector terminal.

(9) According to an exemplary embodiment of the connector terminal wire, the connector terminal wire has a plating layer containing at least one of Sn and Ag on at least a part of a surface thereof.

When the above-described embodiment is used as a material for a connector terminal, such as a press-fit terminal, it is possible to easily manufacture a plated connector terminal provided with a plating layer made of metal containing Sn or Ag, such as a tin plating layer or silver plating layer, on the surface thereof. Accordingly, in the above-described embodiment, a step of forming a plating layer can be omitted after terminal formation, which contributes to improvement in productivity of the plated connector terminal.

### DETAILED DESCRIPTION OF EMBODIMENTS OF THE PRESENT INVENTION

The embodiments of the present invention will be described in detail below. The element contents are expressed as mass ratio (% by mass or ppm by mass) unless otherwise noted.

[Copper Alloy Wire]

(Composition)

A connector terminal wire according to an embodiment (hereinafter, may be referred to as a “copper alloy wire”) is used as a material for a connector terminal, such as a press-fit terminal, and is composed of a copper alloy containing specific elements in specific ranges. The copper alloy is an Fe—P—Cu-based alloy containing 0.1% or more and 1.5% or less of Fe, 0.02% or more and 0.7% or less of P, and 0% or more and 0.7% or less, in total, of at least one of Sn and Mg, with the balance being Cu and impurities. The impurities refer to mainly impurities that are unavoidably included. Each element will be described in detail below.

Fe

Fe is mainly precipitated in Cu, which is a matrix phase, and contributes to improvement in strength such as tensile strength.

When the Fe content is 0.1% or more, compounds and the like containing Fe and P can be satisfactorily formed, and it is possible to produce a copper alloy wire having excellent strength due to precipitation strengthening. Furthermore, the precipitation suppresses solid solution of P in the matrix phase, and it is possible to produce a copper alloy wire having a high conductivity. Although depending on the amount of P and production conditions, as the Fe content increases, the strength of the copper alloy wire more easily increases. When there is a requirement for higher strength or the like, the Fe content can be set at 0.2% or more, more than 0.35%, 0.4% or more, or 0.45% or more.

When the Fe content is 1.5% or less, coarsening of precipitates containing Fe and the like can be easily suppressed. Consequently, breaks originating from coarse precipitates can be reduced, resulting in excellent strength, and in the manufacturing process, disconnection is unlikely to occur during drawing and the like, resulting in excellent manufacturability. Although depending on the amount of P and production conditions, as the Fe content decreases, coarsening of the precipitates and the like can be more easily suppressed. When there is a requirement for suppression of coarsening of precipitates (reduction of breaks and disconnection), the Fe content can be set at 1.2% or less, 1.0% or less, or less than 0.9%.

P

In the connector terminal wire according to the embodiment, P mainly exists as precipitates together with Fe, and contributes to improvement in strength such as tensile strength, i.e., functions as a precipitation strengthening element.

When the P content is 0.02% or more, precipitates and the like containing Fe and P can be satisfactorily formed, and it is possible to produce a copper alloy wire having excellent strength due to precipitation strengthening. Furthermore, the precipitation decreases the amount of solid solution of P in the matrix phase, and it is possible to produce a copper alloy wire having a high conductivity. Although depending on the amount of Fe and production conditions, as the P content increases, the strength of the copper alloy wire more easily increases. When there is a requirement for higher strength or the like, the P content can be set at 0.05% or more, more than 0.1%, 0.11% or more, or 0.12% or more. Note that part of incorporated P may function as a deoxidizing agent and exist as an oxide in the matrix phase.

When the P content is 0.7% or less, it is possible to easily suppress coarsening of precipitates and the like containing Fe and P, and breaks and disconnection can be reduced. Furthermore, solid solution of excessive P in the matrix phase is reduced, and it is possible to produce a copper alloy wire having a high conductivity. Although depending on the amount of Fe and production conditions, as the P content decreases, the coarsening and the like can be more easily suppressed. When there is a requirement for suppression of coarsening of precipitates (reduction of breaks and disconnection), the P content can be set at 0.6% or less, 0.55% or less, 0.5% or less, or 0.4% or less.

Fe/P

In addition to incorporation of Fe and P in the specific ranges described above, preferably, Fe is incorporated properly relative to P. When the Fe content is equal to or greater than the P content, solid solution of excessive P in the matrix phase and a decrease in conductivity can be easily suppressed, and it is possible to more reliably produce a copper alloy wire having a high conductivity. Furthermore, in the case where Fe is not incorporated properly relative to P, there is a concern that elemental Fe may be precipitated or precipitates and the like containing Fe and P may be coarsened, and the strength-improving effect due to precipitation strengthening may not be obtained properly. However, when Fe is incorporated properly relative to P, the two elements can exist as compounds or the like having proper sizes in the matrix phase, and high conductivity and high strength can be satisfactorily expected. Quantitatively, the ratio of the Fe content to the P content, Fe/P, by mass may be 1.0 or more and 10 or less.

When the ratio Fe/P is 1.0 or more, as described above, the strength-improving effect due to precipitation strengthening can be satisfactorily obtained, resulting in excellent strength. When there is a requirement for higher strength or the like, the ratio Fe/P can be set at 1.5 or more, 2.0 or more, or 2.2 or more. In particular, when the ratio Fe/P is 2.5 or more, conductivity tends to be more excellent, and the ratio Fe/P can be set at 3.0 or more, 3.5 or more, 4.0 or more, or about 4.0, for example, 3.5 or more and 4.5 or less.

When the ratio Fe/P is 10 or less, an excessive content of Fe relative to P can be suppressed, and the coarsening can be easily suppressed. When there is a requirement for suppression of coarsening of precipitates and the like, the ratio Fe/P can be set at 8 or less, 7 or less, or 6 or less.

Sn and Mg

In an embodiment of the copper alloy constituting the connector terminal wire according to the embodiment, the Sn content and the Mg content may be each 0%, i.e., the copper alloy may not substantially contain both Sn and Mg. In this embodiment, by adjusting the amount of Fe, the amount of P, production conditions, and the like, it is possible to produce a copper alloy wire having a high conductivity and high strength. Furthermore, in this embodiment, by suppressing a decrease in conductivity due to incorporation of Sn and Mg, higher conductivity is obtained.

Alternatively, in an embodiment of the copper alloy constituting the connector terminal wire according to the embodiment, at least one of the Sn content and the Mg content may be more than 0%, i.e., the copper alloy may contain at least one of Sn and Mg. In the copper alloy, Sn and Mg each mainly exist as a solid solution in Cu, which is a matrix phase, and when Sn and Mg are incorporated, strength, such as tensile strength, tends to be more excellent. Consequently, in this embodiment, a further increase in strength can be expected. Although depending on production conditions, as the Sn content and the Mg content increase, tensile strength tends to increase, resulting in higher strength, and as the Sn content and the Mg content decrease, conductivity tends to increase. When there is a requirement for much higher strength or the like, at least one of the Sn content and the Mg content, in total, can be set at 0.01% or more, 0.02% or more, or 0.025% or more.

When at least one of Sn and Mg is incorporated in a range of 0.7% or less, in total, by suppressing a decrease in conductivity due to excessive solid solution of Sn and Mg in Cu, it is possible to produce a copper alloy wire having a high conductivity. Furthermore, by suppressing a decrease in workability due to excessive solid solution of Sn and Mg, plastic processing, such as drawing, can be easily performed, resulting in excellent manufacturability. When there is a requirement for high conductivity, good workability, and the like, at least one of Sn and Mg is incorporated, and the total content thereof can be set at 0.6% or less, 0.55% or less, or 0.5% or less.

The content of Sn only may be, for example, 0.08% or more and 0.6% or less, or 0.1% or more and 0.55% or less. In the case where, out of Sn and Mg, Mg is not substantially incorporated and Sn is incorporated, strength tends to be more excellent. In this case, further, when the ratio Fe/P is 4.0 or more, while exhibiting high strength, conductivity tends to be more excellent.

The content of Mg only may be, for example, 0.015% or more and 0.5% or less, or 0.02% or more and 0.45% or less. In the case where, out of Sn and Mg, Sn is not substantially incorporated and Mg is incorporated, conductivity tends to be more excellent. Mg is less likely to decrease conductivity than Sn, and while exhibiting high strength, higher conductivity is likely to be obtained.

When both Sn and Mg are incorporated, in comparison with the case where either one is incorporated, strength is likely to further increase, or conductivity is likely to further increase.

C, Si, and Mn

The copper alloy constituting the connector terminal wire according to the embodiment can contain elements that have a deoxidizing effect on Fe, P, Sn, and the like. Specifically, the copper alloy may contain, in mass ratio, 10 ppm or more and 500 ppm or less, in total, of one or more elements selected from the group consisting of C, Si, and Mn.

If a manufacturing process is performed in an oxygen-containing environment, such as the atmosphere, there is a concern that elements, such as Fe, P, and Sn, may be oxidized. When these elements become oxides, they cannot properly form the precipitates and the like or cannot form a solid solution in the matrix phase. Thus, there is a concern that the effects due to incorporation of these elements, i.e., high conductivity and high strength, may not be obtained properly. There is also a concern that the oxides of these elements may act as starting points for breaks during drawing or the like, leading to a decrease in manufacturability. By incorporating at least one element of C, Mn, and Si, preferably two elements (in this case, C and Mn, or C and Si are preferable), more preferably all the three elements in a specific range, precipitation strengthening and high conductivity can be secured by precipitation of Fe and P, and appropriately, higher strength can be achieved by solid-solution strengthening of Sn. Thus, it is possible to produce a copper alloy wire having excellent conductivity and high strength.

When the total content is 10 ppm or more, oxidation of the above-described elements, such as Fe, can be prevented. As the total content increases, the oxidation prevention effect can be more easily obtained, and the total content can be set at 20 ppm or more, or 30 ppm or more.

When the total content is 500 ppm or less, a decrease in conductivity due to excessive contents of these deoxidizing elements is unlikely to be caused, resulting in excellent conductivity. As the total content decreases, the decrease in conductivity can be more easily suppressed, and therefore, the total content can be set at 300 ppm or less, 200 ppm or less, or 150 ppm or less.

The content of C only is preferably 10 ppm or more and 300 ppm or less, 10 ppm or more and 200 ppm or less, and in particular, 30 ppm or more and 150 ppm or less.

The content of Mn only or the content of Si only is preferably 5 ppm or more and 100 ppm or less, or more than 5 ppm and 50 ppm or less. The total content of Mn and Si is preferably 10 ppm or more and 200 ppm or less, or more than 10 ppm and 100 ppm or less.

When C, Mn, and Si are each incorporated in the range described above, a satisfactory oxidation prevention effect for the elements, such as Fe, can be easily obtained. For example, the oxygen content in the copper alloy can be set at 20 ppm or less, 15 ppm or less, or 10 ppm or less.

(Structure)

In a structure of the copper alloy constituting the connector terminal wire according to the embodiment, for example, precipitates or crystallized products containing Fe and P may be dispersed. When the copper alloy has a structure in which precipitates or the like are dispersed, and preferably, a structure in which fine precipitates or the like are uniformly dispersed, an increase in strength due to precipitation strengthening and securement of high conductivity due to reduced solid solution of P and the like in Cu can be expected.

(Sectional Shape)

The cross-sectional shape of the connector terminal wire according to the embodiment can be appropriately selected depending on the shape of a connector terminal for which the connector terminal wire serves as a material. Typically, the connector terminal wire is a rectangular wire whose cross-sectional shape is quadrilateral, such as rectangular or square. The cross-sectional shape can be changed by adjusting plastic processing conditions. For example, in the case where a die is used, by appropriately selecting the shape of the die, in addition to the rectangular wire, a wire whose cross-sectional shape is circular, elliptical, polygonal such as hexagonal, or the like can be produced.

(Size)

The size of the connector terminal wire according to the embodiment can be appropriately selected within a range in which a connector terminal for which the connector terminal wire serves as a material can be obtained. For example, in the case where a press-fit terminal is produced from the wire as a material, the wire may be cut into a predetermined shape and size. When used as the material for such a connector terminal, the size may be selected so as to include portions to be removed by cutting. For example, the connector terminal wire may have a cross-sectional area of 0.1 mm² or more and 2.0 mm² or less, or in the rectangular wire, the width may be set at about 0.1 mm or more and 3.0 mm or less and the thickness may be set at about 0.1 mm or more and 3.0 mm or less.

(Characteristics)

The connector terminal wire according to the embodiment is composed of a copper alloy having the specific composition described above and is excellent in terms of both conductivity and strength. Quantitatively, the connector terminal wire has at least one, and preferably both, of a conductivity of 40% IACS or more and a tensile strength of 600 MPa or more.

When there is a requirement for a higher conductivity, the conductivity can be set at 45% IACS or more, 50% IACS or more, or 55% IACS or more.

When there is a requirement for a higher strength, the tensile strength can be set at 610 MPa or more, 620 MPa or more, or 630 MPa or more.

Since the connector terminal wire according to the embodiment is composed of a copper alloy having the specific composition described above, even when held at a high temperature for a long period of time, stress relaxation is unlikely to occur. Quantitatively, the connector terminal wire may have a stress relaxation rate of 30% or less after it has been held at 150° C. for a predetermined time selected from a range of 200 hours or more and 1,000 hours or less. More preferably, the stress relaxation rate is 28% or less, or 25% or less. In the stress relaxation test, bending stress may be set at, for example, 50% of the 0.2% proof stress. The connector terminal formed of such a connector terminal wire can satisfactorily maintain an electrical and mechanical connection state with a printed board or the like even if held at a high temperature of about 150° C. for a long period of time during use. That is, the connector terminal wire can form a connector terminal having a high conductivity, high strength, and an excellent stress relaxation property.

When there is a requirement for a higher stress relaxation property, the stress relaxation rate can be set at 30% or less, 28% or less, or 25% or less when the holding time is 1,000 hours. The method for measuring the stress relaxation rate will be described later.

The conductivity, tensile strength, stress relaxation rate, and the like can be set at predetermined values by adjusting the composition and production conditions. For example, when the composition is changed such that the amounts of elements, such as Fe, P, and, as appropriate, Sn and Mg, are increased, or the degree of drawing is increased (the wire is thinned), the tensile strength tends to increase. For example, when a heat treatment is performed during processing, the conductivity may be further increased in some cases (refer to samples subjected to a softening treatment in Test Example 1 which will be described later). When the tensile strength and the like are increased, the stress relaxation property becomes excellent, and the stress relaxation rate tends to decrease (refer to samples Nos. 1-13 and 1-19 in Test Example 1 which will be described later).

(Surface Layer)

The connector terminal wire according to the embodiment can be directly used as a material for a connector terminal, such as a press-fit terminal. The connector terminal wire according to the embodiment can be produced as a plated wire which has a plating layer on at least a part of a surface thereof. By using the plated wire as the material, a plated connector terminal can be easily manufactured, which contributes to improvement in manufacturability of the plated connector terminal. A plated wire having a plating layer only for portions requiring plating in a plated connector terminal can be produced. However, when a plated wire having a plating layer on the entire surface thereof is produced, the plating operation is easy to perform, resulting in excellent manufacturability. In the process for producing a plated wire having a plating layer on the entire surface thereof, the plating layer can be formed on a wire of final shape and size. On the other hand, plating may be performed on the material at a stage prior to the final stage, and after the plating, plastic processing for obtaining a wire of final shape and size may be performed. In this case, since the object to be plated is a material having a simple shape and a relatively large size, plating can be easily performed, and a plated wire provided with a plating layer with a uniform thickness can be easily obtained.

The plating layer in the plated connector terminal adheres to a connection target of the connector terminal (e.g., a conductor of a through-hole portion or the like of a printed board, typically composed of copper or a copper alloy) and functions to maintain a good conducting state. Accordingly, as the constituent metal of the plating layer of the plated wire, a metal having this function can be suitably used. In particular, when a plating layer containing at least one of Sn and Ag is provided, when a plated connector terminal is produced from the plated wire, excellent adhesion between the plating layer and the connector terminal and excellent adhesion between the plating layer and the connection target of the connector terminal can be achieved, which is preferable. Specifically, the plating layer may be composed of at least one metal selected from the group consisting of tin, a tin alloy, silver, and a silver alloy. As an underlying layer for the plating layer containing Sn and Ag, at least one of a nickel plating layer and a copper plating layer can be provided.

The thickness of the plating layer (the total thickness of the underlying layer and the plating layer when the underlying layer is provided) can be appropriately selected, and is, for example, about 0.3 μm or more and 5 μm or less. In this range, the good adhesion due to the presence of the plating layer can be exhibited, and by suppressing detachment of the plating layer due to an excessive thickness, the plating layer can be easily maintained.

[Uses]

The connector terminal wire according to the embodiment can be used as a material for various connector terminals. As described above, because of excellent conductivity, high strength, and excellent in rigidity, spring property, and stress relaxation property, the connector terminal wire according to the embodiment can be suitably used as a material for a press-fit terminal and the like which are required for excellence in both conductivity and strength. In addition, the connector terminal wire according to the embodiment is expected to be used in various fields requiring excellence in both conductivity and strength.

### Advantageous Effects

The connector terminal wire according to the embodiment is composed of a copper alloy having a specific composition and therefore, has excellent conductivity and high strength. These advantageous effects will be specifically described in Test Example 1. By using such a connector terminal wire as a material for a connector terminal and appropriately subjecting the wire to cutting and the like, it is possible to provide a connector terminal having excellent conductivity and high strength. Furthermore, because of high strength, it is expected that a connector terminal having an excellent stress relaxation property can be provided.

[Production Method]

The connector terminal wire according to the embodiment can be produced, for example, by a production method including the steps described below. The outline of the individual steps will be described below, and then each of the steps will be described in detail.

<Continuous casting step> A molten metal of the copper alloy having the specific composition described above is continuously cast to produce a cast material.

<Drawing step> The cast material or a processed material obtained by subjecting the cast material to working is subjected to drawing to produce a drawn material having a predetermined size.

<Forming step> The drawn material having a predetermined size is subjected to plastic processing to produce a connector terminal wire having a predetermined shape.

<Heat treatment step> The material after the <continuous casting step> and before the <forming step> is subjected to an aging treatment.

In the case where a connector terminal wire provided with the plating layer is produced, the following <plating step> is provided, for example, before the <forming step> or after the <forming step>.

<Plating step> A plating layer containing at least one of Sn and Ag is formed on at least a part of a surface of the target wire to produce a plated wire.

The heat treatment can include, in addition to the aging treatment, at least one of an intermediate heat treatment and a solution treatment, which will be described below.

The solution treatment is a heat treatment, and one purpose thereof is to form a supersaturated solid solution. The solution treatment can be performed at any time after the continuous casting step and before the aging treatment.

The intermediate heat treatment is a heat treatment, and one purpose thereof is to remove the strain caused by processing and to improve workability in the case where plastic processing is performed after the continuous casting and before the forming step. Depending on conditions, aging and softening can be expected to a certain extent. The intermediate heat treatment may be performed on the processed material before drawing, the intermediate drawn material during drawing, the drawn material of final size after drawing and before the forming step, or the like.

<Continuous Casting Step>

In this step, a molten metal of above-described copper alloy containing Fe, P, and, as appropriate, Sn and Mg in specific ranges is continuously cast to produce a cast material. Here, when melting is performed in a vacuum, oxidation of elements, such as Fe, P, and, as appropriate, Sn, can be prevented. On the other hand, when melting is performed in the atmosphere, atmospheric control is not required, and productivity can be improved. In this case, in order to prevent oxidation of the elements due to oxygen in the atmosphere, the above-described C, Mn, and Si (deoxidizing elements) are preferably used.

In a method for adding C (carbon), for example, a molten metal surface of the molten metal may be covered with charcoal pieces, charcoal powder, or the like. In this case, C can be supplied into the molten metal from charcoal pieces, charcoal powder, or the like in the vicinity of the molten metal surface.

Regarding Mn and Si, raw materials containing these elements may be separately prepared and mixed into the molten metal. In this case, even when portions exposed from gaps formed between charcoal pieces, charcoal powder particles, or the like on the molten metal surface are brought into contact with oxygen in the atmosphere, oxidation in the vicinity of the molten metal surface can be suppressed. Examples of the raw materials include elemental Mn, elemental Si, an alloy of Mn and Fe, and an alloy of Si and Fe.

In addition to incorporation of the deoxidizing elements, when a crucible and a mold, each made of high-purity carbon containing small amounts of impurities, are used, impurities are unlikely to be mixed into the molten metal, which is preferable.

In the connector terminal wire according to the embodiment, typically, Fe and P are made to exist as precipitates, and in the case where at least one of Sn and Mg is incorporated, Sn and Mg are made to exist as solid solutions. Therefore, in the process of producing the connector terminal wire, preferably, a step of forming a supersaturated solid solution is included. For example, a solution treatment step of performing a solution treatment can be separately provided. In this case, a supersaturated solid solution can be formed at any time. On the other hand, when continuous casting is performed, by increasing the cooling rate to produce a cast material of a supersaturated solid solution, without separately providing a solution treatment step, it is possible to produce a copper alloy wire having excellent electrical and mechanical characteristics in the end. Since the number of production steps can be decreased, excellent manufacturability can be obtained. Accordingly, in the method of producing the connector terminal wire, it is proposed to perform continuous casting, in particular, to perform rapid cooling by increasing the cooling rate in the cooling process.

As the continuous casting method, various methods, such as a belt and wheel method, a twin-belt method, and an up-casting method, can be used. In particular, in the up-casting method, impurities, such as oxygen, can be decreased, and oxidation of Cu, Fe, P, Sn, and the like can be easily prevented, which is preferable. The cooling rate in the cooling process is preferably more than 5° C./sec, more than 10° C./sec, or 15° C./sec or more.

The cast material can be subjected to various types of processing, such as plastic processing and cutting. Examples of the plastic processing include conform extrusion, rolling (hot, warm, cold), and the like. Examples of the cutting include peeling and the like. By performing such processing, surface defects of the cast material can be reduced, and disconnection and the like can be reduced during drawing, thus enabling improvement in productivity. In particular, when an upcast member is subjected to such processing, the disconnection and the like are unlikely to occur.

<Drawing Step>

In this step, the cast material, the processed material obtained by subjecting the cast material to processing, an intermediate heat-treated material obtained by subjecting the processed material to an intermediate heat treatment, or the like is subjected to at least one pass, typically, multiple passes of drawing (cold), and thereby, a drawn material having a predetermined size is produced. In the case where multiple passes are performed, the degree of processing for each pass may be appropriately adjusted depending on the composition, the predetermined size, or the like. In the case where multiple passes are performed, by performing an intermediate heat treatment between the passes, workability and the like can be enhanced as described above.

<Forming Step>

In this step, a connector terminal wire having the final shape is produced by plastic processing. The plastic processing can be rolling or the like, but can be drawing in which a die with a predetermined shape is used. In this case, a long connector terminal wire can be continuously produced, which is suitable for mass production. As the die, for example, by using a modified die having a quadrilateral through-hole, a rectangular wire whose cross-sectional shape is quadrilateral can be produced.

The size of the drawn material to be subjected to the forming step is preferably close to the size of a connector terminal wire having the final shape. In this case, the degree of processing to obtain the final shape can be decreased, and by reducing the strain introduced by processing, it is possible to produce a connector terminal wire having a high conductivity. When the intermediate heat treatment is performed before the forming step, while it is possible to form, with high accuracy, a connector terminal wire having excellent workability in the forming step and having a predetermined final shape and a predetermined size, high strength can be achieved because of the strength-improving effect due to work hardening.

<Intermediate Heat Treatment>

In the case where the intermediate heat treatment is performed by batch processing, for example, the following conditions may be used:

{Intermediate Heat Treatment Conditions}

(Heat treatment temperature) 300° C. or higher and 550° C. or lower, preferably, 350° C. or higher and 500° C. or lower

(Holding time) 1 hour or more and 40 hours or less, preferably, 3 hours or more and 20 hours or less

In the case where a processed material obtained by processing the cast material is subjected to an intermediate heat treatment, since the processed material has a relatively larger cross-sectional area (is thicker) than a wire of final size, in the heat treatment, it is considered that batch processing, in which the heating state of the entire heating target is easily controlled, can be easily used. Since the intermediate drawn material and the drawn material have a relatively small cross-section, continuous processing may be used. Regarding conditions for the intermediate heat treatment, for the purpose of improvement in workability and the like, the temperature and time may be selected from the ranges described above depending on the composition and the like. By removing the strain and the like, the conductivity can be expected to be recovered, and even when plastic processing, such as drawing, is performed after the intermediate heat treatment, maintenance of a high conductivity can be expected. Furthermore, when peeling or the like is performed after the intermediate heat treatment, surface defects due to the heat treatment can be reduced.

<Heat Treatment Step>

In this step, a heat treatment (aging treatment) is performed mainly for the purpose of artificial aging in which precipitates containing Fe and P are precipitated from the material (typically, a supersaturated solid solution). The heat treatment can satisfactorily achieve a strength-improving effect due to precipitation strengthening by the precipitates and the like and an effect of maintaining a high conductivity due to reduced solid solution in Cu. Furthermore, softening can be expected to a certain extent by the heat treatment, and excellent workability is exhibited when plastic processing, such as drawing, is performed after the heat treatment.

The heat treatment (aging treatment) can be performed at any time after the continuous casting step. Specifically, the treatment may be performed before the <drawing step> (heat treatment target: the cast material or the processed material), during drawing (heat treatment target: an intermediate drawn material), immediately after the <drawing step> (heat treatment target: a drawn material having a predetermined size), after the <forming step> (heat treatment target: a wire having a predetermined shape), or the like. In particular, the treatment is preferably performed before the <forming step>.

Regarding the heat treatment conditions (aging conditions), as described above, it is considered that batch processing, in which the heating state is easily controlled, can be easily used. For example, the conditions are as follows:

{Aging Conditions}

(Heat treatment temperature) 350° C. or higher and 550° C. or lower, preferably, 400° C. or higher and 500° C. or lower

(Holding time) 1 hour or more and 40 hours or less, preferably, 3 hours or more and 20 hours or less

The conditions may be selected from the above-described ranges depending on the composition (type of element, content), the processed state, and the like. Regarding specific examples, refer to Test Example 1 which will be described later.

<Plating Step>

In the case where a plating layer is formed on a material before the <forming step>, a plating layer can be formed, for example, on a drawn material which is a round wire having a circular cross-section, or the like. In this case, since the object to be plated has a simple shape and is thick to some extent, a plating layer with a uniform thickness can be easily formed with high accuracy, resulting in excellent manufacturability.

In the case where a plating layer is formed on a wire having the final shape which has been subjected to the <forming step>, there is no concern that the plating layer may be damaged when subjected to plastic processing in the forming step.

The plating layer can be formed by using a known method, such as electroplating or chemical (electroless) plating, depending on the desired composition. As described above, an underlying layer may be formed. The thickness of the plating layer may be adjusted such that the final thickness is a predetermined thickness.

### Test Example 1

Copper alloy wires having various compositions were produced under various production conditions, and their characteristics were checked.

The copper alloy wires, each being a rectangular wire having the size shown in Table 1 with a rectangular cross-sectional shape and provided with a plating layer, were produced by the following three production patterns (A), (B), and (C). In all of the production patterns, the cast material described below was prepared.

(Cast Material)

Electrolytic copper (purity: 99.99% or more) and master alloys containing the elements shown in Table 1 or the simple elements were prepared as raw materials. The prepared raw materials were melted in the atmosphere by using a high purity carbon-made crucible (impurity content: 20 ppm by mass or less) to thereby produce molten metals of copper alloys. The compositions of the copper alloys (with the balance being Cu and impurities) are shown in Table 1. The “hyphen (-)” means not incorporated therein.

By using the molten metals of the copper alloys and a high purity carbon-made mold (impurity content: 20 ppm by mass or less), continuously cast materials having a circular cross-section with the wire diameter described below were produced by an up-casting method. The cooling rate was set at more than 10° C./sec.

In this test, charcoal pieces were prepared as a carbon source, and iron alloys containing Si or Mn were prepared as a Si source or Mn source. The molten metal surface of each of the molten metals was sufficiently covered with the charcoal pieces so that the molten metal surface was not brought into contact with the atmosphere. The amount of charcoal pieces was adjusted such that the amount of C mixed into the molten metal due to contact between the charcoal pieces and the molten metal surface corresponded to the content of “C” (mass ppm) under the “trace element” shown in Table 1.

Iron alloys were mixed into the molten metal while adjusting the amounts of iron alloys such that the contents of Si and Mn relative to the molten metal corresponded to the contents of “Si” and “Mn” (mass ppm) under the “trace element” shown in Table 1.

(Production Pattern of Copper Alloy Wire)

(A) continuous casting (wire diameter ϕ 12.5 mm)
conform extrusion (wire diameter ϕ 9.5 mm)
drawing (wire diameter ϕ 2.6 mm or ϕ 1.6 mm)
heat treatment (under conditions of aging treatment in Table 1)
drawing (wire diameter ϕ 1.0 mm)
intermediate heat treatment (under conditions of softening treatment in Table 1)
forming (rectangular drawing by using modified die, 0.64 mm×0.64 mm 0.4 mm², or 0.64 mm long×1.50 mm wide≈1 mm²)
formation of tin plating layer (thickness 1.5 μm)

(B) continuous casting (wire diameter ϕ 12.5 mm)
cold rolling (wire diameter ϕ 9.5 mm)
intermediate heat treatment (temperature: selected from the range of 400° C. to 550° C., holding time: selected from the range of 4 hours to 16 hours)
peeling (wire diameter ϕ 8 mm)
drawing (wire diameter ϕ 2.6 mm or ϕ 1.6 mm)
heat treatment (under conditions of aging treatment in Table 1)
drawing (wire diameter ϕ 1.0 mm)
intermediate heat treatment (under conditions of softening treatment in Table 1)
forming (rectangular drawing by using modified die, 0.64 mm×0.64 mm 0.4 mm², or 0.64 mm long×1.50 mm wide≈1 mm²)
formation of tin plating layer (thickness 1.5 μm)

(C) continuous casting (wire diameter ϕ 12.5 mm)
drawing (wire diameter ϕ 9.5 mm)
peeling (wire diameter ϕ 8 mm)
drawing (wire diameter ϕ 2.6 mm or ϕ 1.6 mm)
heat treatment (under conditions of aging treatment in Table 1)
drawing (wire diameter ϕ 1.0 mm)
intermediate heat treatment (under conditions of softening treatment in Table 1)
forming (rectangular drawing by using modified die, 0.64 mm×0.64 mm 0.4 mm², or 0.64 mm long×1.50 mm wide≈1 mm²)
formation of tin plating layer (thickness 1.5 μm)

In production patterns (A), (B), and (C), regarding samples whose conditions of softening treatment are described in Table 1, the intermediate heat treatment (softening treatment) was conducted under the conditions shown in Table 1 at the wire diameter shown in Table 1. This intermediate heat treatment can be omitted (refer to samples in which the softening treatment column indicates “-” in Table 1).

Regarding the copper alloy wires produced in accordance with production patterns (A), (B), and (C), tensile strength (MPa) and conductivity (% IACS) were checked. The results are shown in Table 1.

The tensile strength (MPa) was measured in accordance with JIS Z 2241 (Metal material tensile test method, 1998) by using a general-purpose tensile tester. The conductivity (% IACS) was measured by a bridge method.

TABLE 1

| | Composition | | | | | | | | | | Aging treatment | | |
|---|---|---|---|---|---|---|---|---|---|---|---|---|---|
| | | | | | | mass | Trace element | | | | Wire | | |
| Sample | (mass %) | | | | | ratio | (mass ppm) | | | | diameter | Temperature | Time |
| No. | Cu | Fe | P | Mg | Sn | Fe/P | C | Mi | Si | Process | (mm) | (° C.) | (h) |
| 1-1 | Bal. | 0.45 | 0.11 | — | 0.21 | 4.1 | 30 | <10 | <10 | C | 2.6 | 500 | 8 |
| 1-2 | Bal. | 0.45 | 0.11 | — | 0.21 | 4.1 | 30 | <10 | <10 | C | 2.6 | 500 | 8 |
| 1-3 | Bal. | 0.45 | 0.11 | — | 0.21 | 4.1 | 30 | <10 | <10 | C | 2.6 | 500 | 8 |
| 1-4 | Bal. | 0.46 | 0.19 | 0.027 | 0.21 | 2.4 | 20 | <10 | <10 | B | 2.6 | 500 | 8 |
| 1-5 | Bal. | 0.46 | 0.19 | 0.027 | 0.21 | 2.4 | 20 | <10 | <10 | B | 2.6 | 500 | 8 |
| 1-6 | Bal. | 0.48 | 0.19 | 0.049 | 0.21 | 2.5 | 70 | <10 | <10 | C | 2.6 | 500 | 8 |
| 1-7 | Bal. | 0.48 | 0.19 | 0.049 | 0.21 | 2.5 | 70 | <10 | <10 | A | 2.6 | 500 | 8 |
| 1-8 | Bal. | 0.57 | 0.2 | — | 0.3 | 2.9 | 100 | <10 | <10 | A | 2.6 | 500 | 8 |
| 1-9 | Bal. | 0.57 | 0.2 | — | 0.3 | 2.9 | 100 | <10 | <10 | C | 2.6 | 500 | 8 |
| 1-10 | Bal. | 0.57 | 0.19 | 0.27 | — | 3.0 | 20 | <10 | <10 | C | 2.6 | 500 | 8 |
| 1-11 | Bal. | 0.57 | 0.19 | 0.27 | — | 3.0 | 20 | <10 | <10 | C | 2.6 | 500 | 8 |
| 1-12 | Bal. | 0.57 | 0.13 | — | 0.3 | 4.4 | 50 | <10 | <10 | B | 2.6 | 500 | 8 |
| 1-13 | Bal. | 0.57 | 0.13 | — | 0.3 | 4.4 | 50 | <10 | <10 | B | 2.6 | 500 | 8 |
| 1-14 | Bal. | 0.57 | 0.13 | — | 0.3 | 4.4 | 50 | <10 | <10 | B | 1.6 | 500 | 8 |
| 1-15 | Bal. | 0.58 | 0.2 | 0.043 | — | 2.9 | 100 | <10 | <10 | C | 2.6 | 500 | 8 |
| 1-16 | Bal. | 0.58 | 0.2 | 0.043 | — | 2.9 | 100 | <10 | <10 | C | 2.6 | 500 | 8 |
| 1-17 | Bal. | 0.61 | 0.15 | — | 0.14 | 4.1 | 50 | <10 | <10 | B | 2.6 | 450 | 8 |
| 1-18 | Bal. | 0.61 | 0.15 | — | 0.14 | 4.1 | 50 | <10 | <10 | A | 1.6 | 450 | 8 |
| 1-19 | Bal. | 0.68 | 0.15 | — | 0.34 | 4.5 | 100 | <10 | <10 | A | 2.6 | 500 | 8 |
| 1-20 | Bal. | 0.68 | 0.15 | — | 0.34 | 4.5 | 100 | <10 | <10 | A | 2.6 | 500 | 8 |
| 1-21 | Bal. | 0.68 | 0.15 | — | 0.34 | 4.5 | 100 | <10 | <10 | B | 2.6 | 500 | 8 |
| 1-22 | Bal. | 0.99 | 0.24 | — | 0.49 | 4.1 | 40 | <10 | <10 | C | 1.6 | 500 | 8 |
| 1-23 | Bal. | 0.99 | 0.24 | — | 0.49 | 4.1 | 40 | <10 | <10 | C | 2.6 | 500 | 8 |
| 1-101 | Bal. | 0.089 | 0.028 | — | 0.27 | 3.2 | 60 | <10 | <10 | C | 2.6 | 500 | 8 |
| 1-102 | Bal. | 0.089 | 0.028 | — | 0.27 | 3.2 | 60 | <10 | <10 | C | 2.6 | 500 | 8 |

| | Softening treatment | | | | Characteristics | |
|---|---|---|---|---|---|---|
| | Wire | | | Final wire | Tensile | |
| Sample | diameter | Temperature | Time | size | strength | Conductivity |
| No. | (mm) | (° C.) | (h) | mm × mm | (MPa) | (% IACS) |
| 1-1 | — | — | — | 0.64 × 0.64 | 670 | 55 |
| 1-2 | ϕ1.0 | 500 | 4 | 0.64 × 0.64 | 620 | 67 |
| 1-3 | ϕ1.0 | 500 | 4 | 0.64 × 1.50 | 600 | 68 |
| 1-4 | — | — | — | 0.64 × 0.64 | 655 | 64 |
| 1-5 | — | — | — | 0.64 × 1.50 | 640 | 65 |
| 1-6 | — | — | — | 0.64 × 0.64 | 680 | 70 |
| 1-7 | — | — | — | 0.64 × 1.50 | 660 | 73 |
| 1-8 | — | — | — | 0.64 × 0.64 | 670 | 60 |
| 1-9 | — | — | — | 0.64 × 1.50 | 650 | 63 |
| 1-10 | — | — | — | 0.64 × 0.64 | 650 | 67 |
| 1-11 | — | — | — | 0.64 × 1.50 | 630 | 70 |
| 1-12 | — | — | — | 0.64 × 0.64 | 660 | 50 |
| 1-13 | ϕ1.0 | 500 | 4 | 0.64 × 0.64 | 620 | 62 |
| 1-14 | ϕ1.0 | 500 | 4 | 0.64 × 1.50 | 610 | 64 |
| 1-15 | — | — | — | 0.64 × 0.64 | 620 | 85 |
| 1-16 | — | — | — | 0.64 × 1.50 | 600 | 87 |
| 1-17 | ϕ1.0 | 450 | 4 | 0.64 × 0.64 | 620 | 65 |
| 1-18 | ϕ1.0 | 450 | 4 | 0.64 × 1.50 | 600 | 68 |
| 1-19 | — | — | — | 0.64 × 0.64 | 690 | 48 |
| 1-20 | ϕ1.0 | 500 | 4 | 0.64 × 0.64 | 650 | 62 |
| 1-21 | ϕ1.0 | 500 | 4 | 0.64 × 1.50 | 630 | 64 |
| 1-22 | ϕ1.0 | 500 | 4 | 0.64 × 0.64 | 670 | 60 |
| 1-23 | ϕ1.0 | 500 | 4 | 0.64 × 1.50 | 650 | 63 |
| 1-101 | — | — | — | 0.64 × 0.64 | 440 | 72 |
| 1-102 | — | — | — | 0.64 × 1.50 | 410 | 74 |

Comparisons are made between final wires with the same size in the description below.

As is evident from Table 1, the copper alloy wires of samples Nos. 1-1 to 1-23 have a conductivity of 40% IACS or more and a tensile strength of 600 MPa or more, and in comparison with samples Nos. 1-101 and 1-102, high conductivity and high strength are exhibited in a well-balanced manner. One reason for this is considered to be that, in each of samples Nos. 1-1 to 1-23, the wire is composed of a copper alloy having a specific composition containing Fe, P, and, as appropriate, Sn and Mg in the specific ranges. Consequently, it is considered that the strength-improving effect due to precipitation strengthening based on incorporation of Fe and P and the effect of maintaining the conductivity of Cu due to reduced solid solution of P and the like in the matrix phase are obtained, and also that the strength-improving effect due to solid-solution strengthening of Sn and Mg, as appropriate, is obtained. Another reason for this is considered to be that, since the ratio Fe/P satisfies a range of 1.0 or more and 10 or less, compounds of Fe and P are properly precipitated, and solid solution of excessive P can be reduced. Furthermore, another reason for this is considered to be that, here, incorporation of appropriate amounts of C, Mn, and Si can prevent oxidation of Fe, P, Sn, and the like, and the strength-improving effect due to Fe and P, the strength-improving effect due to Sn as appropriate, and the effect of maintaining the conductivity of Cu due to reduced solid solution can be easily obtained.

Regarding the conductivity, all of samples No. 1-1 to No. 1-23 have a conductivity of 45% IACS or more, many samples have a conductivity of 50% IACS or more, or 60% IACS or more, and there are samples having a conductivity of 62% IACS or more.

Regarding the tensile strength, all of samples No. 1-1 to No. 1-23 have a tensile strength of 600 MPa or more, and many samples have a tensile strength of 610 MPa or more, or 620 MPa or more.

Attention will be paid to compositions.

Here, when the ratio Fe/P is 2.5 or more (samples Nos. 1-6 and 1-7), 2.9 or more (samples Nos. 1-15 and 1-16), 3.0 or more (samples Nos. 1-10 and 1-11), or 3.5 or more (samples Nos. 1-2, 1-3, 1-17, and 1-18), the conductivity is likely to increase.

In addition to Fe and P, when Sn is incorporated (samples Nos. 1-17 and 1-18) and Mg is incorporated (samples Nos. 1-15 and 1-16), even if the amount of Sn or Mg is very small, it is evident that the samples have high conductivity and high strength. It is expected from these samples that, even a copper alloy wire that contains Fe and P in specific ranges and does not contain Mg and Sn has excellent conductivity and high strength and quantitatively, meets a conductivity of 40% IACS or more and a tensile strength of 600 MPa or more.

In addition to Fe and P, out of Sn and Mg, when Sn is incorporated, strength tends to be more excellent, and when Mg is incorporated, conductivity tends to be more excellent (for example, refer to and compare between samples Nos. 1-8 and 1-9 and Nos. 1-10 and 1-11).

In the case where, in addition to Fe and P, Sn is incorporated, as the Sn content increases, strength tends to increase, and as the Sn content decreases, conductivity tends to increase (for example, refer to and compare among samples Nos. 1-22 and 1-23, Nos. 1-20 and 1-21, and Nos. 1-17 and 1-18).

In the case where, in addition to Fe and P, Mg is incorporated, as the Mg content increases, strength tends to increase, and as the Mg content decreases, conductivity tends to increase (for example, refer to and compare between samples Nos. 1-10 and 1-11 and Nos. 1-15 and 1-16).

In the case where, in addition to Fe and P, both Sn and Mg are incorporated, in comparison with the case where Sn or Mg only is incorporated, strength is likely to further increase (for example, refer to and compare among samples Nos. 1-4 and 1-5 (both), Nos. 1-2 and 1-3 (Sn only), and Nos. 1-15 and 1-16 (Mg only). Furthermore, in some cases, conductivity is higher and strength is higher (for example, refer to and compare among samples Nos. 1-6 and 1-7 (both), Nos. 1-2 and 1-3 (Sn only), and Nos. 1-10 and 1-11 (Mg only).

Furthermore, from this test, it is considered that, when the C content is 100 ppm by mass or less, the total content of Mn and Si is 20 ppm by mass or less, and the total content of the three elements is 150 ppm by mass or less, in particular 120 ppm by mass or less, decreases in conductivity and strength due to incorporation of these elements are unlikely to be caused, and the elements function as an antioxidant so that Fe and P can be properly precipitated, and Sn and the like can be made into a solid solution.

Regarding the heat treatment, this test shows that, when the intermediate heat treatment (softening treatment) is performed on the wire having a predetermined size, the conductivity tends to be increased compared with the case where the intermediate heat treatment is not performed (for example, refer to samples Nos. 1-2 and 1-1, samples Nos. 1-13 and 1-12, and samples Nos. 1-20 and 1-19).

Furthermore, the wires of samples Nos. 1-1 to 1-23 have an excellent stress relaxation property. Here, the stress relaxation rate was checked on the wires of samples Nos. 1-13 and 1-19, a wire made of phosphor bronze, and a wire made of brass by the following procedure.

The stress relaxation rate is measured by a cantilever method with reference to the Japan Copper and Brass Association technical standard “Method for stress relaxation test by bending for thin sheets and strips” (JCBA, T309: 2004). A sample is subjected to a predetermined bending stress, the sample bent like a bow, in a state of being held by a holding block, is placed in a heating furnace, and the heat resistance test described below is performed. The heat resistance test conditions are as follows: the predetermined bending stress at 50% of the 0.2% proof stress, the heating temperature at 150° C., and the holding time (hour) selected from a range of 10 hours to 1,000 hours.

From the initial set δ₀ (mm) of the specimen required to obtain the predetermined bending stress and the permanent set δₜ (mm) described below, the stress relaxation rate (%)=(permanent set δₜ/initial set δ₀)×100 is obtained. The permanent set δₜ is defined as the set of the specimen occurring when the bending stress is unloaded after the heat resistance test.

As the wire of phosphor bronze (C5191) and the wire of brass (C2600), commercially available materials (0.64 mm×0.64 mm) were prepared.

Table 2 shows characteristics [conductivity (% IACS), tensile strength (MPa), and 0.2% proof stress (MPa)] of the wire of each sample, and the stress relaxation rate (%) for each holding time (h). The characteristics of the wire of each sample were measured by the metal material tensile test method and the bridge method.

TABLE 2

| | | | Tensile | 0.2% proof | | | |
|---|---|---|---|---|---|---|---|
| Sample | | Conductivity | strength | stress | Stress relaxation rate (%) | | |
| No. | Composition | % IACS | MPa | MPa | 50 h | 200 h | 1000 h |
| 1-13 | CuFePSn | 62 | 620 | 583 | 15 | 16 | 18 |
| 1-19 | CuFePSn | 48 | 690 | 648 | 13 | 15 | 15 |
| 1-201 | C5191 | 13 | 718 | 636 | 24 | 30 | 43 |
| 1-202 | C2600 | 25 | 721 | 571 | 41 | 47 | 56 |

As is evident from Table 2, the wires of samples Nos. 1-13 and 1-19 each have high conductivity and high strength in a well-balanced manner and a low stress relaxation rate, indicating that stress relaxation is unlikely to occur, compared with sample No. 1-201 of phosphor bronze and sample No. 1-202 of brass. In particular, in samples Nos. 1-13 and 1-19, the stress relaxation rate is lower than that of sample No. 1-201 of phosphor bronze which is considered to have an excellent spring property, and the stress relaxation rate is 30% or less not only in the case where the holding time is relatively short (50 hours), but even after elapse of 200 hours or 1,000 hours. Here, the stress relaxation rate of phosphor bronze at a holding time of 100 hours is 28%. In contrast, in each of wires of samples Nos. 1-13 and 1-19, the stress relaxation rate after elapse of 1,000 hours is 25% or less, or 20% or less, and in sample No. 1-19, the stress relaxation rate is lower at 15% or less. One reason for such an excellent stress relaxation property is considered to be that, since samples Nos. 1-13 and 1-19 each are composed of a copper alloy having the specific composition, the ratio, 0.2% proof stress/tensile strength, is higher than that of phosphor bronze. Furthermore, from this test, it is also anticipated that, regarding the wires of samples Nos. 1-1 to 1-12, Nos. 1-14 to 18, and Nos. 1-20 to 1-23, the stress relaxation rate is substantially equal to that of samples Nos. 1-13 and 1-19, and an excellent stress relaxation property equal to or greater than that of phosphor bronze is exhibited.

This test shows that the copper alloy wire composed of a copper alloy containing Fe, P, and, as appropriate, Sn and Mg in specific ranges has excellent conductivity and high strength. The test also shows that the copper alloy wire has an excellent stress relaxation property. Furthermore, this test shows that, by selecting the specific composition and performing a heat treatment including at least an aging treatment, it is possible to obtain a wire having a high conductivity and high strength. In particular, as in this test example, by combining a solution treatment step with the continuous casting step, and by forming the final shape by drawing using a modified die, the number of steps can be decreased, and a long wire can be continuously produced, thus showing excellent manufacturability.

The scope of the present invention is not limited to the examples described above but is defined by the appended claims, and is intended to include all modifications within the meaning and scope equivalent to those of the claims.

For example, the composition of the copper alloy, the width and thickness of the rectangular wire, the heat treatment conditions, and the like in Test Example 1 can be appropriately changed.

1. A connector terminal wire comprising:
0.1% by mass or more and 1.5% by mass or less of Fe;
0.02% by mass or more and 0.7% by mass or less of P; and
0% by mass or more and 0.7% by mass or less, in total, of at least one of Sn and Mg,
with the balance being Cu and impurities.

2. The connector terminal wire according to claim 1, comprising 0.01% by mass or more and 0.7% by mass or less, in total, of at least one of Sn and Mg.

3. The connector terminal wire according to claim 1, wherein the ratio Fe/P, by mass, is 1.0 or more and 10 or less.

4. The connector terminal wire according to claim 1, further comprising, in mass ratio, 10 ppm or more and 500 ppm or less, in total, of one or more elements selected from the group consisting of C, Si, and Mn.

5. The connector terminal wire according to claim 1, wherein the connector terminal wire has a conductivity of 40% IACS or more and a tensile strength of 600 MPa or more.

6. The connector terminal wire according to claim 1, wherein the connector terminal wire has a stress relaxation rate of 30% or less after it has been held at 150° C. for a predetermined time selected from a range of 200 hours or more and 1,000 hours or less.

7. The connector terminal wire according to claim 1, wherein the connector terminal wire has a cross-sectional area of 0.1 mm² or more and 2.0 mm² or less.

8. The connector terminal wire according to claim 1, wherein the connector terminal wire is a rectangular wire whose cross-sectional shape is quadrilateral.

9. The connector terminal wire according to claim 1, wherein the connector terminal wire has a plating layer containing at least one of Sn and Ag on at least a part of a surface thereof.
